(19) United States
(12) Patent Application Publication
(10) Pub. No.: US 2026/0175710 A1
(43) Pub. Date: Jun. 25, 2026

(54) BATTERY POWER CONTROL METHOD AND SYSTEM FOR NEW ENERGY SHIP

(71) Applicant: Shanghai Marine Equipment Research Institute, Shangahi (CN)

(72) Inventors: Bin HU, Shanghi (CN); Zhilin Zeng, Shangahi (CN); Shaoyuan Wang, Shangahi (CN); Zhongling Liu, Shangahi (CN); Xu Zhao, Shanghai (CN)

(73) Assignee: Shanghai Marine Equipment Research Institute, Shangahi (CN)

(21) Appl. No.: 19/539,022

(22) Filed: Feb. 13, 2026

Related U.S. Application Data
(63) Continuation of application No. PCT/CN2024/125220, filed on Oct. 16, 2024.

(30) Foreign Application Priority Data
Jan. 12, 2024 (CN) 202410052007.1

(51) Int. Cl. B60L 50/64; H02J 3/38

(52) U.S. Cl. CPC B60L 50/64; H02J 3/38; H02J 3/381

(57) ABSTRACT

The provided is a battery power control method and system for a new energy ship. The battery power control method for a new energy ship includes: respectively enabling battery packs to supply power to buses, where a bidirectional direct current (DC)-DC converter is disposed between adjacent ones of the buses to form a looped bus, and loads respectively draw power from annular segments of the looped bus; checking power supply states of regions of the buses; and by controlling the bidirectional DC-DC converter between the adjacent buses, dispatching surplus energy of a bus to an energy-deficient bus. The provided employs smaller-capacity bidirectional DC-DC converters, can flexibly dispatch energy between various battery packs, and can effectively balance remaining capacities between the battery packs. The provided has a small and controllable system risk when the bus is short-circuited, and does not compromise power performance of the ship in a single-point fault.

### CROSS-REFERENCE TO THE RELATED APPLICATIONS

This application is a continuation application of International Application No. PCT/CN2024/125220, filed on Oct. 16, 2024, which is based upon and claims priority to Chinese Patent Application No. 202410052007.1, filed on Jan. 12, 2024, the entire contents of which are incorporated herein by reference.

### TECHNICAL FIELD

The present disclosure relates to power supply and distribution technologies for battery systems for new energy ships, and in particular to a battery power control method and system for a new energy ship.

### BACKGROUND

At present, battery packs of most pure battery-powered ships are connected to a shipboard direct-current (DC) power grid through DC-DC converters. However, the DC-DC converters are high in cost and affect the overall efficiency of the ships. Moreover, the DC-DC converters have large footprints, and it is difficult to calculate the DC short-circuit currents and to implement a fully selective protection scheme. When one battery pack or one DC-DC converter has a fault, propulsive power or daily load power needs to be limited to achieve an energy balance. Otherwise, the DC bus will experience voltage collapse.

In some pure battery-powered ships, battery packs are not connected to the shipboard DC power grid through the DC-DC converters, such that remaining capacities of the battery packs are unbalanced and cannot be effectively regulated, reducing the cruising range of the ship. Moreover, a large number of battery packs are connected in parallel to affect the service life of batteries. When one battery pack has a fault, the propulsion system or the daily inverter system on a bus corresponding to the battery pack fail, thereby seriously affecting the safety of the ship. Furthermore, the redundancy of the propulsion system is relatively low.

### SUMMARY

In view of the above problem, the present disclosure provides a battery power control method and system for a new energy ship.

The technical solutions of the present disclosure are as follows: A battery power control method for a new energy ship includes: respectively enabling battery packs to supply power to buses, where a bidirectional DC-DC converter is disposed between adjacent ones of the buses to form a looped bus, and loads respectively draw power from annular segments of the looped bus; checking power supply states of regions of the buses; and by controlling the bidirectional DC-DC converter between the adjacent buses, dispatching surplus energy of a bus to an energy-deficient bus.

Further, the dispatching surplus energy of a bus to an energy-deficient bus includes:
when only one bus has the surplus energy or adjacent buses have the surplus energy, taking the one bus or the adjacent buses as an energy dispatching main body, and transmitting a half of calculated surplus energy to adjacent buses from two sides of the energy dispatching main body, where
when two non-adjacent buses have the surplus energy, there are three cases:
a first case: if the surplus energy of a maximum-energy bus is greater than a half of a propulsive load power value, and deficient energy of a minimum-energy bus is greater than the half of the propulsive load power value, the half of the propulsive load power value is transmitted from the maximum-energy bus to the minimum-energy bus;
a second case: if the surplus energy of the maximum-energy bus is greater than the half of the propulsive load power value, and the deficient energy of the minimum-energy bus is less than the half of the propulsive load power value, all surplus power of the maximum-energy bus is transmitted to the minimum-energy bus; and
a third case: if the surplus energy of the maximum-energy bus is less than the half of the propulsive load power value, the surplus energy is transmitted to adjacent buses from two sides of the maximum-energy bus.

Further, the checking power supply states of regions of the buses includes: when one battery pack fails, determining that a voltage of a DC bus drops instantaneously; if a load corresponding to the DC bus is a propulsion system, when a propulsion inverter detects a sudden drop of the voltage of the DC bus and that both a voltage drop rate and a voltage value respectively exceed preset values, controlling a propulsion motor with a sudden drop of a rotational speed to enter a generating state for about 100 ms, and triggering bidirectional DC-DC converters on two sides of the DC bus to enter a droop control mode; and if the load corresponding to the DC bus is a daily load, when a daily inverter detects the sudden drop of the voltage of the DC bus and that both the voltage drop rate and the voltage value respectively exceed the preset values, controlling the daily inverter to enter a rectification state to maintain the voltage of the DC bus for 100 ms, and triggering the bidirectional DC-DC converters on the two sides of the DC bus to enter the droop control mode, thereby preventing the DC bus corresponding to the failing battery pack from losing power.

A battery power system for a new energy ship includes four 1,000-kWh battery packs, two 200-kWh propulsion systems, two 200-kW daily inverters configured to supply power to a daily load, four 100-kW bidirectional DC-DC converters, and a power management control system, where battery packs 1-4 are respectively connected to buses 1-4; a propulsion system 1 #is connected to a bus 1; a daily inverter system 1 #is connected to a bus 2; a daily inverter system 2 #is connected to a bus 3; a propulsion system 2 #is connected to a bus 4; a bidirectional DC-DC converter 12 is disposed between the bus 1 and the bus 2, a bidirectional DC-DC converter 23 is disposed between the bus 2 and the bus 3, a bidirectional DC-DC converter 34 is disposed between the bus 3 and the bus 4, and a bidirectional DC-DC converter 41 is disposed between the bus 4 and the bus 1, thereby forming a looped bus; loads respectively draw power from annular segments of the looped bus; the two 200-kWh propulsion systems each include a 200-kW propulsion inverter and a 200-kW propulsion motor; each daily inverter system includes one 200-kW daily inverter, a sinusoidal filter, and a 250-kVA daily transformer; and a power system of the power management control system is controlled with the battery power control method for a new energy ship.

The present disclosure has the following beneficial effects: According to the battery power control method and system for a new energy ship provided by the present disclosure, four battery packs are respectively directly connected to DC buses, the bidirectional DC-DC converters are respectively disposed between the buses, two propulsion systems and two daily inverter systems are provided, and the power management control system with a multi-strategy algorithm is provided. The present disclosure employs smaller-capacity bidirectional DC-DC converters, can flexibly dispatch energy between various battery packs, and can effectively balance remaining capacities between the battery packs. The present disclosure has a small and controllable system risk when the bus is short-circuited, and does not compromise power performance of the ship in a single-point fault, thereby effectively improving the reliability and safety of the ship.

### BRIEF DESCRIPTION OF THE DRAWINGS

FIG. 1 is a schematic diagram of a battery power system for a new energy ship according to the present disclosure;

FIG. 2 is a schematic diagram of a first solution of a battery power system for a conventional ship;

FIG. 3 is a schematic diagram of a battery power system for a new energy ship when one battery pack has a fault according to the present disclosure;

FIG. 4 is a schematic diagram of a second solution of a battery power system for a conventional ship;

FIG. 5 is a schematic diagram of a control strategy of a battery power system for a new energy ship during normal navigation according to the present disclosure;

FIG. 6 is a schematic diagram of a control strategy of a battery power system for a new energy ship when one battery pack is locked in operation according to the present disclosure; and

FIG. 7 is a schematic diagram of a control strategy for four modes of a battery power system for a new energy ship according to the present disclosure.

### DETAILED DESCRIPTION OF THE EMBODIMENTS

The present disclosure will be described in detail below with reference to the drawings and specific embodiments. The embodiments are implemented on the premise of the technical solutions of the present disclosure. The following presents detailed implementations and specific operation processes. The protection scope of the present disclosure, however, is not limited to the following embodiments.

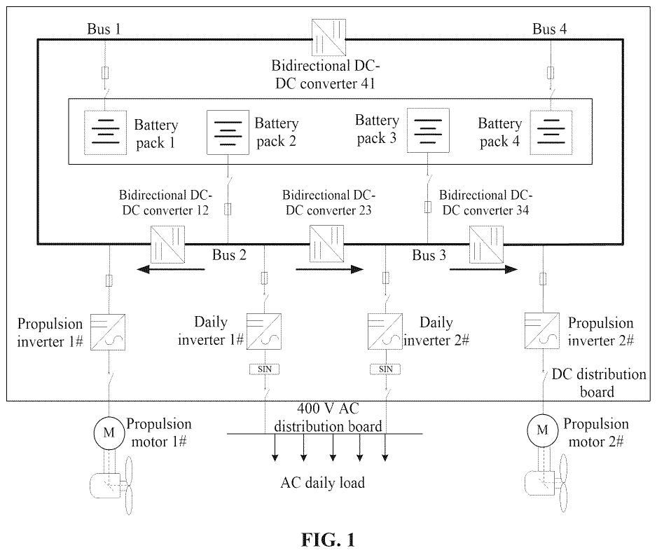

FIG. 1 shows an embodiment of a pure battery power control system for a ship in the present disclosure. The pure battery power control system for the ship includes four 1,000-kWh battery packs, two 200-kWh propulsion systems, two 200-kW daily inverters configured to supply power to a daily load, four 100-kW bidirectional DC-DC converters, and a power management control system. Battery packs 1-4 are respectively connected to buses 1-4. Propulsion system 1 #is connected to bus 1. Daily inverter system 1 #is connected to bus 2. Daily inverter system 2 #is connected to bus 3. Propulsion system 2 #is connected to bus 4. Bidirectional DC-DC converter 12 is disposed between the bus 1 and the bus 2, bidirectional DC-DC converter 23 is disposed between the bus 2 and the bus 3, bidirectional DC-DC converter 34 is disposed between the bus 3 and the bus 4, and bidirectional DC-DC converter 41 is disposed between the bus 4 and the bus 1, thereby forming a looped bus. Loads respectively draw power from annular segments of the looped bus.

The two 200-kWh propulsion systems each include a 200-kW propulsion inverter and a 200-kW propulsion motor. Each daily inverter system includes one 200-kW daily inverter, a sinusoidal filter, and a 250-kVA daily transformer.

1. Comparison between the solution of the present disclosure and the conventional solutions

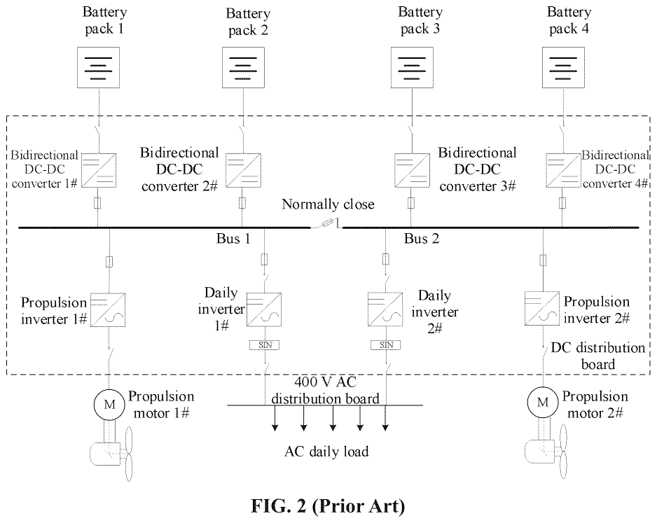

A) Comparison with a First Conventional Solution (FIG. 2)

The solution of the present disclosure includes four 100-kW bidirectional DC-DC converters. In the first conventional solution of the battery power system (as shown in FIG. 2, the battery pack is connected to the bus through the bidirectional DC-DC converter, all buses are respectively directly connected through switches, and the load draws power from the bus), four 200-kW DC-DC converters are required. With the same number of DC-DC converters, the power in the solution of the present disclosure is reduced by half.

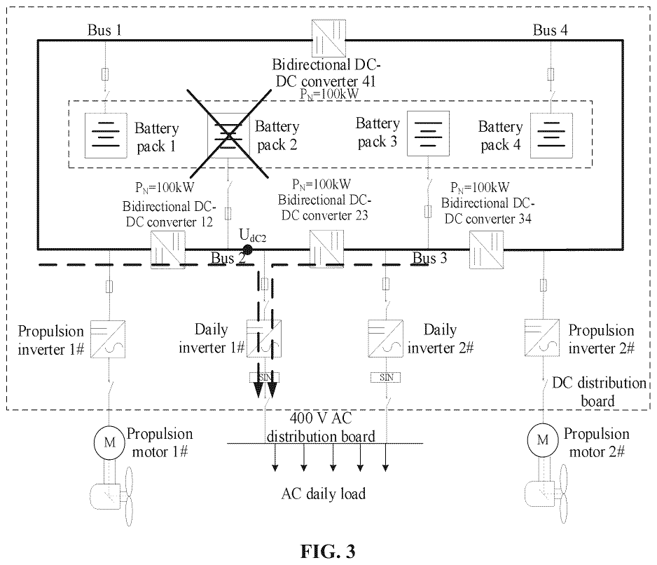

For the conventional battery power system shown in FIG. 2, if any battery pack or DC-DC converter has a fault, the power of the propulsion system or the daily inverter system must be limited. Otherwise, the DC bus will experience voltage collapse due to an overcurrent. In the solution of the present disclosure, if any battery pack has a fault, as shown in FIG. 3, two 100-kW bidirectional DC-DC converters on two sides of the bus where the battery pack is located are used to supply power to the 200-kW propulsion system or the 200-kW daily inverter system of this bus, maintaining the power of the propulsion system and the daily inverter system unchanged.

In the first conventional solution, it is difficult to calculate the short-circuit current of the DC bus, and to implement the fully selective protection scheme. In the solution of the present disclosure, the short-circuit current of the DC bus is calculated easily, and the fully selective protection scheme is implemented easily for the single branch.

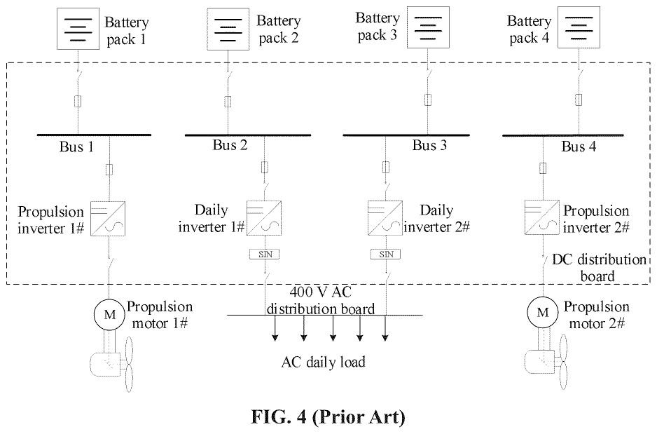

B) Comparison with a Second Conventional Solution (FIG. 4)

As shown in the second conventional solution (FIG. 4), one battery pack is directly connected to one propulsion system or one daily inverter system. If the battery pack has a fault and ceases operation, the propulsion system or daily inverter system will fail, which seriously affects the safety of the ship. In addition, in the second conventional solution, the capacity of the battery pack is difficult to dispatch, which affects the cruising range and reliability of the ship.

### 2. Implementation of a Control Method During Normal Navigation

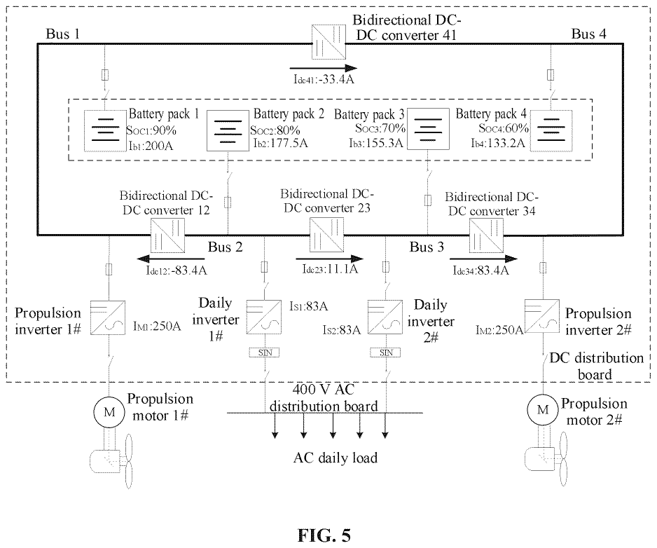

As shown in FIG. 5, state of charge (SOC) values (Soc₁, Soc₂, Soc₃, and Soc₄) of the four battery packs are 90%, 80%, 70%, and 60% respectively. The current IM of the propulsion inverter 1 #, the current I_{S1} of the daily inverter 1 #, the current I_{S2} of the daily inverter 2 #, the current I_{M2} of the propulsion inverter 2 #are respectively 250 A, 83 A, 83 A, and 250 A.

Since an output current ratio of the four battery packs follows I_{b1}: I_{b2}: I_{b3}: I_{b4}=Soc₁: Soc₂: Soc₃: Soc₄, it is derived that the I_{b1}, the I_{b2}, the I_{b3}, and the I_{b4} are respectively 200 A, 177.5 A, 155.3 A, and 133.2 A. The calculation process is as follows:

### s1: Calculation of Regional Current Values

Since I_{A1}=I_{b1}-I_{M1}=200-250 A=−50 A

Similarly, it is derived that the I_{A2}, the I_{A3}, and the I_{A4} are respectively 94.5 A, 72.3 A, and −116.8 A.

### s2: Mode Determination

Since there are two values greater than 0 among I_{A1}-I_{A4}, num1=2 is set, with maximum values denoted in sequence as I_{Max1}=94.5, and I_{Max2}=72.3. Since there are two values less than 0 among I_{A1}-I_{A4}, num2=2 is set, with minimum values denoted in sequence as I_{Min1}=−116.8, and I_{Min2}=−50.

Therefore, mode 2 is determined.

### s3: Logic Control

An equation set

$$\{ \begin{matrix}{I}_{A 1} = {I}_{d c 41} - {I}_{d c 12} = - 50 \\ {I}_{A 2} = {I}_{d c 12} - {I}_{d c 23} = 94.5 \\ {I}_{A 3} = {I}_{d c 23} - {I}_{d c 34} = 72.3 \\ {I}_{A 4} = {I}_{d c 34} - {I}_{d c 41} = - 116.8\end{matrix}$$

is established for an initial state

A logic for controlling the mode 2 is as follows: The I_{Max1} and the I_{Max2} are respectively generated by regions where the DC bus 2 and the DC bus 3 are located. Excess power generated by the DC bus 2 and the DC bus 3 is equally distributed to the other two regions. The current I_{dc34} of the bidirectional DC-DC converter 34 is set to 0.5*(I_{Max1}+I_{Max2})−0.5*(94.5+72.3) A=83.4 A, and the current I_{dc12} of the bidirectional DC-DC converter 12 is set to −0.5*(I_{Max1}+I_{Max2}) A=−83.4 A.

After redistribution, Idc41=−33.4 A and Idc23=−11.1 A can be obtained via the equations.

3. Implementation of a control method when one battery pack is locked in operation

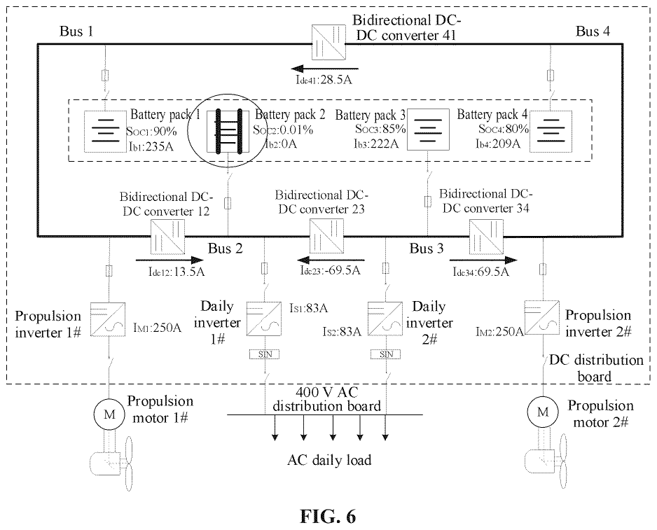

As shown in FIG. 6, SOC values (Soc₁, Soc₂, Soc₃, and Soc₄) of four battery packs are respectively 90%, 0.01% (the system set value when the battery pack is locked in operation), 85%, and 80%. The I_{M1}, the I_{S1}, the I_{S2}, and the I_{M2} are respectively 250 A, 83 A, 83 A, and 250 A

Due to I_{b1}: I_{b2}: I_{b3}: I_{b4}-Soc₁: Soc₂: Soc₃: Soc₄, it is derived that the I_{b1}, the I_{b2}, the I_{b3}, and the I_{b4} are respectively 235 A, 0 A, 222 A, and 209 A. The calculation process is as follows:

### s1: Calculation of Regional Current Values

Since I41=I_{b1}-IM1=235-250 A=−15 A

Similarly, it is derived that the I_{A2}, the I_{A3}, and the I_{A4} are respectively −83 A, 139 A, and −41 A.

### s2: Mode Determination

Since there is one value greater than 0 among I_{A1}-I_{A4}, num1=1 is set, with a maximum value denoted as I_{Max1}=139. Since there are three values less than 0 among I_{A1}-I₄₄, num2=3 is set, with minimum values denoted in sequence as I_{Min1}=−83, I_{Min2}=−41, and I_{Min3}=−15.

Therefore, mode 1 is determined.

### s3: Logic Control

An equation set

$$\{ \begin{matrix}{I}_{A 1} = {I}_{d c 41} - {I}_{d c 12} = - 15 \\ {I}_{A 2} = {I}_{d c 12} - {I}_{d c 23} = - 83 \\ {I}_{A 3} = {I}_{d c 23} - {I}_{d c 34} = 139 \\ {I}_{A 4} = {I}_{d c 34} - {I}_{d c 41} = - 41\end{matrix}$$

is established for an initial state

A logic for controlling the mode 1 is as follows: The I_{Max1} is generated by a region where the DC bus 3 is located. Excess power generated by the DC bus 3 is equally distributed to two adjacent regions. The current I_{dc34} of the bidirectional DC-DC converter 34 is set to 0.5*I_{Max1}=69.5, and the current I_{dc23} of the bidirectional DC-DC converter 23 is set to −0.5*I_{Max1}=−69.5.

After redistribution, I_{dc41}=28.5 A and I_{dc12}=13.5 A can be obtained via the equations.

### 4. Schematic View of a Control Strategy

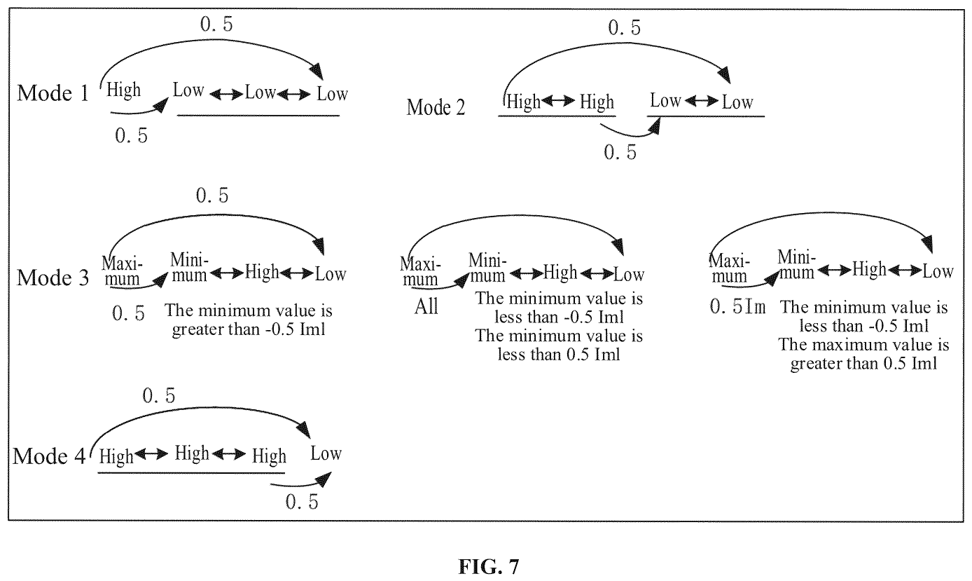

FIG. 7 shows the schematic view of the control strategy.

In the mode 1, only one bus has surplus energy, and a half of the surplus energy of the bus is transmitted to adjacent buses from two sides of the bus.

In the mode 2, two adjacent buses have surplus energy, and a half of total surplus energy of the two adjacent buses is transmitted to two energy-deficient buses.

In the mode 3, two non-adjacent buses have surplus energy. If the surplus energy of a maximum-energy bus is greater than a half of a propulsive load power value, and deficient energy of a minimum-energy bus is greater than the half of the propulsive load power value, the half of the propulsive load power value is supplied from the maximum-energy bus to the minimum-energy bus.

In the mode 3, the two non-adjacent buses have the surplus energy. If the surplus energy of the maximum-energy bus is greater than the half of the propulsive load power value, and the deficient energy of the minimum-energy bus is less than the half of the propulsive load power value, all surplus power of the maximum-energy bus is supplied to the minimum-energy bus.

In the mode 3, the two non-adjacent buses have the surplus energy. If the surplus energy of the maximum-energy bus is less than the half of the propulsive load power value, the surplus energy is transmitted to adjacent buses from two sides of the maximum-energy bus.

In the mode 4, three adjacent buses have surplus energy, and a half of total surplus energy of the three adjacent buses is transmitted to the unique energy-deficient bus from left and right sides.

5. Instantaneous Control Implementation when One Battery Pack has a Fault

When one battery pack fails, a voltage of a DC bus drops instantaneously. When a propulsion inverter detects a sudden drop of the voltage of the DC bus and that both a voltage drop rate and a voltage value respectively exceed preset values, a propulsion motor with a sudden drop of a rotational speed is controlled to enter a generating state for about 100 ms, and bidirectional DC-DC converters on two sides of the DC bus are triggered to enter a droop control mode. When a daily inverter detects the sudden drop of the voltage of the DC bus and that both the voltage drop rate and the voltage value respectively exceed the preset values, the daily inverter is controlled to enter a rectification state to maintain the voltage of the DC bus for 100 ms, and the bidirectional DC-DC converters on the two sides of the DC bus are triggered to enter the droop control mode. This makes preparations for the bidirectional DC-DC converters to switch from an energy dispatching mode to the droop control mode, preventing the DC bus from losing power.

### 6. Droop Control Implementation of the Bidirectional DC-DC Converter

During normal operation, the bidirectional DC-DC converter receives a current command from the power management system, so as to dispatch energy to balance SOC states of the battery packs.

When one battery pack has a fault, the bidirectional DC-DC converter is triggered to enter the droop control mode. The droop control method is as follows: As shown in FIG. 3, when the battery pack 2 has a fault, the bus 1 and the bus 3 provide power for it.

U_{A} is a droop starting voltage set as 650 V, and U_{B} is a droop ending voltage set as 550 V. When the U_{dc2} is the actual DC voltage of the bus and is 600 V, the P_{N} is the rated power of the bidirectional DC-DC converter and is 100 kW.

The bidirectional DC-DC converter 12 and the bidirectional DC-DC converter 23 on two sides of the bus 2 are used to inject a current to the bus 2:

$$I = \frac{( {U}_{A} - {U}_{d c 2} ) {P}_{N}}{( {U}_{A} - {U}_{d c 2} ) {U}_{d c 2}} = 83.3 A .$$

The above described are merely several embodiments of the present disclosure. Although these embodiments are described specifically and in detail, they should not be construed as a limitation to the patent scope of the present disclosure. It should be noted that those of ordinary skill in the art can further make several variations and improvements without departing from the concept of the present disclosure, and all of these fall within the protection scope of the present disclosure. Therefore, the protection scope of the present disclosure shall be subject to the protection scope defined by the claims.

What is claimed is:

1. A battery power control method for a new energy ship, comprising: respectively enabling battery packs to supply power to buses, wherein a bidirectional direct current (DC)-DC converter is disposed between adjacent ones of the buses to form a looped bus, and loads respectively draw power from annular segments of the looped bus; checking power supply states of regions of the buses; and by controlling the bidirectional DC-DC converter between the adjacent buses, dispatching surplus energy of a bus to an energy-deficient bus; wherein the dispatching the surplus energy of the bus to the energy-deficient bus comprises:
when only one bus has the surplus energy or adjacent buses have the surplus energy, taking the one bus or the adjacent buses as an energy dispatching main body, and transmitting a half of calculated surplus energy to adjacent buses from two sides of the energy dispatching main body, wherein
when two non-adjacent buses have the surplus energy, there are three cases:
a first case: if the surplus energy of a maximum-energy bus is greater than a half of a propulsive load power value, and deficient energy of a minimum-energy bus is greater than the half of the propulsive load power value, the half of the propulsive load power value is transmitted from the maximum-energy bus to the minimum-energy bus;
a second case: if the surplus energy of the maximum-energy bus is greater than the half of the propulsive load power value, and the deficient energy of the minimum-energy bus is less than the half of the propulsive load power value, all surplus power of the maximum-energy bus is transmitted to the minimum-energy bus; and
a third case: if the surplus energy of the maximum-energy bus is less than the half of the propulsive load power value, the surplus energy is transmitted to adjacent buses from two sides of the maximum-energy bus.

2. The battery power control method for the new energy ship according to claim 1, wherein the checking the power supply states of the regions of the buses comprises: when one battery pack fails, determining that a voltage of a DC bus drops instantaneously; if a load corresponding to the DC bus is a propulsion system, when a propulsion inverter detects a sudden drop of the voltage of the DC bus and that both a voltage drop rate and a voltage value respectively exceed preset values, controlling a propulsion motor with a sudden drop of a rotational speed to enter a generating state for about 100 ms, and triggering bidirectional DC-DC converters on two sides of the DC bus to enter a droop control mode; and if the load corresponding to the DC bus is a daily load, when a daily inverter detects the sudden drop of the voltage of the DC bus and that both the voltage drop rate and the voltage value respectively exceed the preset values, controlling the daily inverter to enter a rectification state to maintain the voltage of the DC bus for 100 ms, and triggering the bidirectional DC-DC converters on the two sides of the DC bus to enter the droop control mode, thereby preventing the DC bus corresponding to the failing battery pack from losing power.

3. A battery power system for a new energy ship, comprising: four 1,000-kWh battery packs, two 200-kWh propulsion systems, two 200-kW daily inverters configured to supply power to a daily load, four 100-kW bidirectional direct current (DC)-DC converters, and a power management control system, wherein battery packs 1-4 are respectively connected to buses 1-4; a propulsion system 1 #is connected to a bus 1; a daily inverter system 1 #is connected to a bus 2; a daily inverter system 2 #is connected to a bus 3; a propulsion system 2 #is connected to a bus 4; a bidirectional DC-DC converter 12 is disposed between the bus 1 and the bus 2, a bidirectional DC-DC converter 23 is disposed between the bus 2 and the bus 3, a bidirectional DC-DC converter 34 is disposed between the bus 3 and the bus 4, and a bidirectional DC-DC converter 41 is disposed between the bus 4 and the bus 1, thereby forming a looped bus; loads respectively draw power from annular segments of the looped bus; the two 200-kWh propulsion systems each comprise a 200-kW propulsion inverter and a 200-kW propulsion motor; each daily inverter system comprises one 200-kW daily inverter, a sinusoidal filter, and a 250-kVA daily transformer; and a power system of the power management control system is controlled with the battery power control method for the new energy ship according to claim 1.

4. The battery power system according to claim 3, wherein in the battery power control method, the checking the power supply states of the regions of the buses comprises: when one battery pack fails, determining that a voltage of a DC bus drops instantaneously; if a load corresponding to the DC bus is a propulsion system, when a propulsion inverter detects a sudden drop of the voltage of the DC bus and that both a voltage drop rate and a voltage value respectively exceed preset values, controlling a propulsion motor with a sudden drop of a rotational speed to enter a generating state for about 100 ms, and triggering bidirectional DC-DC converters on two sides of the DC bus to enter a droop control mode; and if the load corresponding to the DC bus is a daily load, when a daily inverter detects the sudden drop of the voltage of the DC bus and that both the voltage drop rate and the voltage value respectively exceed the preset values, controlling the daily inverter to enter a rectification state to maintain the voltage of the DC bus for 100 ms, and triggering the bidirectional DC-DC converters on the two sides of the DC bus to enter the droop control mode, thereby preventing the DC bus corresponding to the failing battery pack from losing power.
